(19) United States
(12) Patent Application Publication
(10) Pub. No.: US 2005/0063013 A1
(43) Pub. Date: Mar. 24, 2005

(54) Enhancing black & white image quality with limited image processing resources

(75) Inventors: Xing Li, Webster, NY (US); Ramesh Nagarajan, Pittsford, NY (US)

Correspondence Address: Patent Documentation Center;Xerox Corporation, Xerox Square 20th Floor, 100 Clinton Ave. S., Rochester, NY, 14644, US

(73) Assignee: Xerox Corporation

(21) Appl. No.: 10/667,703

(22) Filed: Sep. 22, 2003

(51) Int. Cl. H04N 1/40; G06K 15/00; G06K 9/34; G06K 9/54; G06T 7/00

(52) U.S. Cl. 358/2.1; 382/304; 382/180

(57) ABSTRACT

What is disclosed is a system and method to improve the black and white image quality of tag-based color imaging systems in a color image path by making use of the additional two channels available. The present method exploits the resources of the two un-utilized channels during black and white processing. The single channel black-and white image is replicated into all three channels at the output of the storage memory. Segmentation tags are fed into each channel to control the image processing. Additional filters, TRCs and rendering methods will be available due to processing in all the 3 channels. Resources may additionally include such things as: filters, TRC mapping, and halftoning modules. The video output from the output image processing is merged back based on the segmentation tags. Different de-screen filters with various cut-off frequencies and enhancement filters are applied to the image based on pixel classification. One example of such an application is to use different cut-off frequency filters for text-on-tint pixels and different halftone frequency pixels. The number of TRCs and halftone screens available per page has also increased by 3 times. The method also applies to any image path that has extra channels available for certain scanning/copying modes.

### FIELD OF THE INVENTION

The present invention generally relates to methods for enhancing black and white images and, more particularly, to methods to enhance image quality in an environment wherein image processing resources are restricted or otherwise limited.

### BACKGROUND

Color scanners and multifunction devices are becoming more and more popular these days, leading to the necessity of supporting color image processing in addition to black & white (b/w) image processing functions. In the case of black and white (b/w) scanning or copying, typically only one of the channels is used for processing, as imaging systems with tag-based image processing functions can be resource constrained. For example, in order to provide unique processing based on tags, multiple filters, TRCs and rendering modules need to be available (such as: different halftone screens, various error diffusion schemes, hybrid screens, and the like). But due to cost constraints, only limited options are provided in each of the channels.

In most cases, b/w image path is not considered differently from color image path. Using a single channel in the color image path and setting the parameters appropriately one can achieve B/W image path. Special image-processing functions that require cross channel information are usually performed at the start of the Input Image processing function and/or at the end of the Output Image processing function. In the case of B&W scanning or copying only one of the channels is used for processing. Image processing performed in the output side is usually constrained by resources. For example, in order to make use of the segmentation tags and provide unique processing based on tags, multiple filters, TRCs and rendering modules (different halftone screens, various error diffusion schemes, hybrid screens, etc) need to be available. Due to cost constraints, each of the channels only provides limited options since they require memory (either external or internal)—for example, 2 filters, 2 TRCs and 2 halftone screens.

In today's world, image segmentation is getting more and more sophisticated and one can easily identify different categories of pixel classification very accurately and in order to improve image quality one has to perform unique image processing in the output side. This requires more filters or TRCs or rendering methods, which increases the cost of the chip. Also, most of the scanners provide a manual windowing function by which a user could manually select regions within an image and ask to perform unique image processing functions on them. Again due to lack of resources to accomplish this function, one either does not allow user to select resources beyond certain threshold or reduces the productivity by processing the image multiple times.

### BRIEF SUMMARY

What is disclosed is a system and method to improve the black and white image quality of tag-based color imaging systems in a color image path by making use of the additional two channels available. The present method exploits the resources of the two un-utilized channels during black and white processing. The single channel black and white image is replicated into all three channels at the output of the storage memory. Segmentation tags are fed into each channel to control the image processing. Additional filters, TRCs and rendering methods will be available due to processing in all the 3 channels. Resources may additionally include such things as: filters, TRC mapping, and halftoning modules. The video output from the output image processing is merged back based on the segmentation tags. Different de-screen filters with various cut-off frequencies and enhancement filters are applied to the image based on pixel classification. One example of such an application is to use different cut-off frequency filters for text-on-tint pixels and different halftone frequency pixels. The number of TRCs and halftone screens available per page has also increased by 3 times. The method also applies to any image path that has extra channels available for certain scanning/copying modes.

### BRIEF DESCRIPTION OF THE DRAWINGS

The preferred embodiments and other aspects of the invention will become apparent from the following detailed description of the invention when read in conjunction with the accompanying drawings which are provided for the purpose of describing embodiments of the invention and not for limiting same, in which:

FIG. 1 illustrates an image path of a typical scanner or multifunction device; and

FIG. 2 illustrates the usage of additional channels for enhancing the black & white image quality in accordance with the present invention.

### DESCRIPTION OF THE SPECIFICATION

What is disclosed is a system and method to improve the quality of black and white images in a color image path of tag-based color imaging systems.

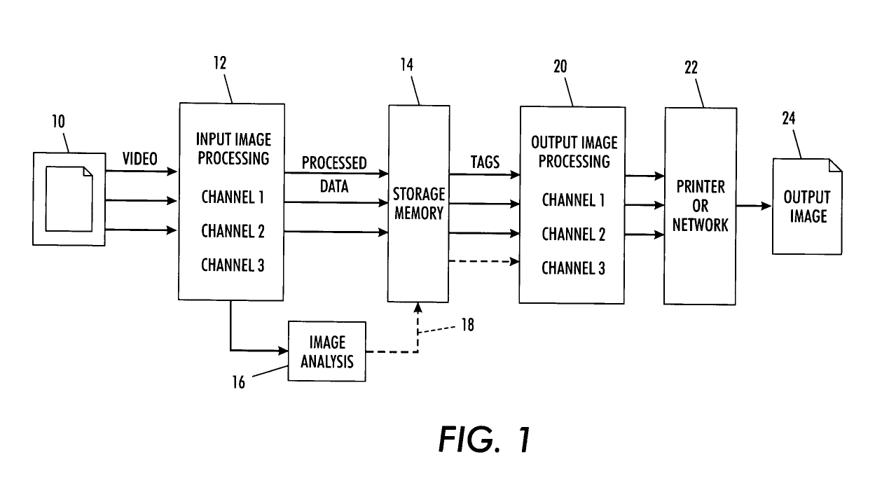

Attention is now being made to FIG. 1, which illustrates major elements of a typical color and b/w image path in a typical scanner or multifunction device. An image is first scanned by scanner 10 and converted to video image signal data which is passed to input control module 12. This module performs necessary processing of the image prior to the image data being moved to an intermediate storage memory module at 14. The intermediate storage memory could be as small as a few lines of memory or as large as a whole page memory. At the same time as the image signal data is being processed by the input control module, analysis is also performed on the image data by image analysis module 16 to determine the characteristics of the image through some form of segmentation. The analysis module generates segmentation tags 18 for each pixel describing its classification (e.g., continuous tone, low frequency halftone, high frequency halftone, text, etc).

An output image processing module 20 retrieves the image data stored in memory. Image-processing functions (e.g. filtering, Tonal Reproduction Curves or TRCs, Rendering) are performed therein based on the various segmentation tags stored therewith associated with each pixel of the image. The processed image is then sent out to either a printer in the case of a copy job or to the network in the case of scan to export job (shown collectively at 22). The processing in the input and output side is performed on a channel-by-channel basis. An output image 24 is generated.

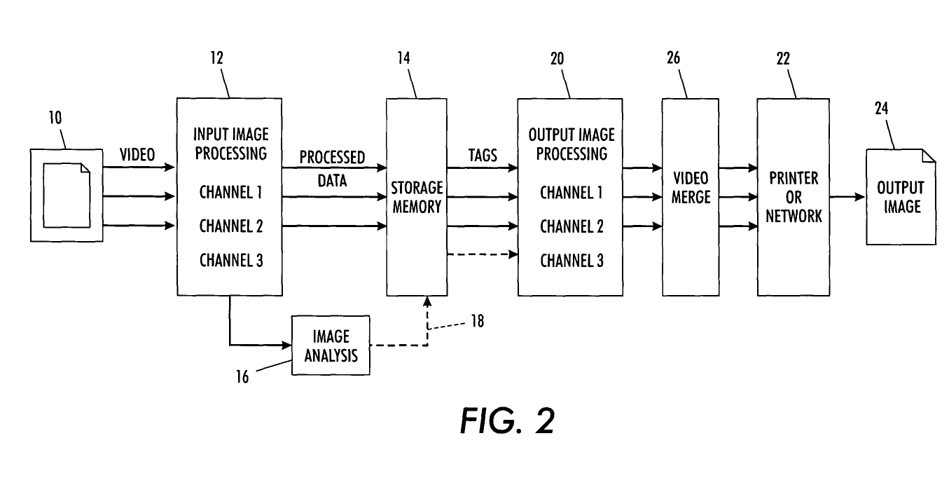

Attention is now directed to FIG. 2 illustrating the elements of FIG. 1 with the addition of video merge module 26 inserted between the output image processing module 20 and the printer or network printing device at 22. Segmentation tags 18 which have been stored in memory module 14 are fed into each channel of the output image processing module 20 to be used to control image processing. The single channel black and white image is replicated into all three channels at the output of the storage memory. The present method exploits the resources of the two un-utilized channels during black and white image processing. Additional filters, TRCs and rendering methods will be available due to processing in all the 3 channels. Resources may additionally include such things as: filters, TRC mapping, and halftoning modules. Within video merge module 26, the video signal output from the output image processing is merged back based on the segmentation tags. Therein, different de-screen filters with various cut-off frequencies and enhancement filters are applied to the image based on pixel classification. One example is to use different cut-off frequency filters for text-on-tint pixels and different halftone frequency pixels. The number of TRCs and halftone screens available per page has also increased by 3 times. The method also applies to any image path that has extra channels available for certain scanning/copying modes.

Even though the examples illustrated above were concerning filtering, TRC and rendering applications, the invention is not restricted to only these image processing functions. One could use this idea for any image processing application that requires multiple resources to enhance image quality. Also the description was pertained to enhancing B&W image quality, but it is again not restricted to only that. One could use this idea to apply to any image path that has more channels to work with for certain modes. Another such example is using the extra channel in a CMYK image path for processing in 3-channel color space (i.e., LAB, RGB, sRGB, YcbCr etc). The use of the 4^{th} channel could be used to provide additional resources for the luminance channel.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method to improve quality of black and white images of tag-based color imaging systems in a color image path, comprising:
a) receiving data processed from an input image;
b) receiving image analysis tags associated with the pixels of said input image data;
c) providing said tags to each channel of said image processing module to control image processing;
d) performing image processing on said image data to provide a video signal output thereof;
e) replicating said video output signal on all output channels of said image processing module;
f) merging each video signal from each of said output channels based on the tags; and
g) outputting said merged video signal.

2. A method to improve image quality as in claim 1 wherein the tags are determined from one or more characteristics of the image through segmentation.

3. A method to improve image quality as in claim 1 wherein the received data processed from said input image is obtained from a memory.

4. A method to improve image quality as in claim 1 wherein said tags are generated in an image analysis module.

5. A method to improve image quality as in claim 4 wherein said tags describe for each pixel its classification (e.g., continuous tone, low frequency halftone, high frequency halftone, text, etc).

6. A method to improve image quality as in claim 1 wherein said image processing includes filtering, Tonal Reproduction Curves or TRCs, and rendering based.

7. A method to improve image quality as in claim 1 wherein different de-screen filters with various cut-off frequencies and enhancement filters are applied to the image based on pixel classification.

8. A method to improve image quality as in claim 1 wherein said image processing comprises multiple resources to enhance image quality.

9. A method to improve image quality as in claim 1 wherein additional channel modes are utilized in a CMYK image path for processing in 3-channel color space.

10. A method to improve image quality as in claim 1 wherein a 4^{th} channel provides resources for the luminance channel.

11. A method to improve image quality as in claim 1 wherein additional channel modes are utilized in a color image path for processing in 1-channel Black and White mode.

12. A system for improving the quality of black and white images in a color image path of tag-bases color imaging systems, comprising:
at least one processor in communication with a storage device;
sufficient software and hardware to perform:
a) receiving data processed from an input image;
b) receiving image analysis tags associated with the pixels of said input image data;
c) providing said tags to each channel of said image processing module to control image processing;
d) performing image processing on said image data to provide a video signal output thereof;
e) replicating said video output signal on all output channels of said image processing module;
f) merging each video signal from each of said output channels based on the tags; and
g) outputting said merged video signal on; and
h) a device for rendering said merged video signal.

13. A system for improving image quality as in claim 12 wherein the tags are determined from one or more characteristics of the image through segmentation.

14. A system for improving image quality as in claim 12 wherein the received data processed from said input image is obtained from a memory.

15. A system for improving image quality as in claim 12 wherein said tags are generated in an image analysis module.

16. A system for improving image quality in claim 15 wherein said tags describe for each pixel its classification (e.g., continuous tone, low frequency halftone, high frequency halftone, text, etc).

17. A system for improving image quality in claim 12 wherein said image processing includes filtering, Tonal Reproduction Curves or TRCs, and rendering based.

18. A system for improving image quality in claim 12 wherein different de-screen filters with various cut-off frequencies and enhancement filters are applied to the image based on pixel classification.

19. A system for improving image quality in claim 12 wherein said image processing comprises multiple resources to enhance image quality.

20. A system for improving image quality in claim 12 wherein additional channel modes are utilized in a CMYK image path for processing in 3-channel color space.

21. A system for improving image quality in claim 12 wherein a 4^{th} channel provides resources for the luminance channel.

22. A system for improving image quality in claim 12 wherein additional channel modes are utilized in a color image path for processing in 1-channel Black and White mode.
